(19) United States
(12) Patent Application Publication
(10) Pub. No.: US 2022/0321365 A1
(43) Pub. Date: Oct. 6, 2022

(54) Power over Ethernet system having multiple power source devices and control device thereof

(71) Applicant: IC Plus Corp., Hsinchu City (TW)

(72) Inventor: Chef HSIAO, Hsinchu City (TW)

(21) Appl. No.: 17/356,600

(22) Filed: Jun. 24, 2021

(30) Foreign Application Priority Data
Mar. 30, 2021 (TW) 110111659

(51) Int. Cl. H04L 12/10; H04L 12/12; G06F 1/26

(52) U.S. Cl. CPC H04L 12/10; H04L 12/12; G06F 1/266

(57) ABSTRACT

Control device for PoE system having multiple power source devices comprises power supply state code generator in connection with the power source devices to convert a power supply state signal into a serial power supply state code; plural control circuits to generate power consumption control signals corresponding to said power supply state code by reference to a power supply to power consumption look-up-table, to control the ON/OFF of plural port switches; a signal bus connecting the power supply state code generator and the control circuits.

### BACKGROUND OF THE INVENTION

### Technical Field

The present invention relates to a power over Ethernet (PoE) system and a control device useful in the system, in particular to a PoE system with a plurality of power source devices, and a control device to be used in such a system.

### Prior Art

In a wired communication network, supplying electrical power to devices on the network through network cables is already a mature technology. For example, the

Power over Ethernet (PoE) power supply system, which is powered by the wiring of the Ethernet, has gradually become popular, due to its advantages in reducing installation costs, as well as centralized power supply and power backup, and safety management. Currently a plurality of PoE systems follow the IEEE 802.3af-2003 standard, which is incorporated herein for reference.

The PoE system provides a scalable function, with which in the initial operation stage, the system can automatically or manually configure its power distribution to the limited number of ports in the system. As time passes, the system can also detect the power supply state automatically, and increase or decrease the number of ports to receive electrical power, based on the detection results in the power supply state. Each power consuming port is connectable by one power consuming device, to receive electrical power from the system.

There are methods to increase power supply in a PoE system. One of the methods is to use multiple power source devices or multiple groups of power supply. The plurality of power source devices is connected to one or more control element in parallel, which control element then supplies or distributes the electrical power of the plural power source devices to individual power consuming devices. Power source devices of non-PoE system can also provide power to the PoE system, to increase its supplied power, as long as the sum of the PoE power supply and the non-PoE power supply can be distributed to one or more loads via Ethernet wire/cables.

In a power supply system wherein a plurality of power source device is used, an important technical problem to be overcome is how to immediately stop supplying power to particular power consuming devices, i.e., to particular ports, when one or more of the plural power source devices shuts down or reduces its output power, in order to avoid the occurrence of overloading on the remaining supplied power. Further, in order to prevent impacts on the remaining power consuming devices due to a shutdown or low-power status, it is also necessary to stop supplying power to the particular power consuming devices immediately or within a very short time, usually within 20 ms, preferably within 2 ms. If the total power consumption of all the connected power consuming devices cannot be reduced within that period, the total system would shut down during the immediate shutdown operation.

The prior art has proposed several solutions to this technical problem, especially means to quickly stop supplying power to sufficient number of power consuming ports, when one or more power source devices fail.

U.S. Pat. No. 7,337,336 No. discloses a “ Method for Rapid Port Power Reduction,” useful in a PoE system with multiple power source devices and allowing quickly reducing or stopping power supplied to particular ports, when the power supply status changes. The method comprises the steps of: Coding of possible power supply states. For example, if the system has 4 power source devices, code 1 is assigned to a power source device in normal operation, while code 0 is assigned otherwise. In this way, 16 power supply state codes can be assigned to represent all possible power supply states. For each of the 16 power supply state codes, a power supply index is assigned, which index indicates ports to be supply power (code 1) and ports not to be supply power (code 0). All power supply state code-power consuming index assignments thus form a look-up-table. When the power supply status of any power source device changes, the change is detected, whereby a new power supply status code is generated. Thereupon, a new power consuming index is picked up from the look-up-table and executed. That is, power supplied to ports coded 0 is shut down, while power supplied to ports coded 1 is maintained.

U.S. Pat. No. 7,908,494 discloses a system and method for multiple power over Ethernet (PoE) power supply management. Power supply status signals indicative of an operating condition of a plurality of PoE power supplies are provided to a plurality of power sourcing equipment (PSE) controller chips. Pre-configured combination logic within each of the PSE controller chips converts an indicated operational state of the plurality of PoE power supplies into a powering decision for each of the Ethernet ports served by the PSE controller chip within one microsecond. Although the immediate power shutting off operation is activated by a change in the power supply state combination, an operation would be activated wherever the power supply state of one power source device changes. It is possible to wire together the power supply state signals with a single state input signal and use the single state input signal to activate the change. This is disclosed in U.S. 2007/0250218, title of the invention: Power management logic that reconfigures a load when a power supply fails.

A method for immediately shutting off power supply to predetermined ports upon change of power supply state is disclosed in TW 2017/29564, “Power source devices and method for power over Ethernet power supply system.” The method continuously detects specific communication ports to obtain the power consumption value along the time axis of the power consuming devices connected to the communication ports, and then determines a power consumption trend value. When the trend value shows that the power consumption of a power consuming device exceeds a power supply upper limit for a predetermined time, the power supply to the power consuming device is stopped.

It can be known from the prior art that, although the conventional emergency power-off mechanism can quickly shut off certain ports, it is only suitable for systems with a small number of power consuming devices. When the number of power consuming devices reaches a considerable level, especially when the ratio of the number of power consuming devices to the number of power source devices is high, the length of the assigned code will be too long and the selectivity will be greatly reduced. Shutting off power supply to particular ports will become difficult.

In addition, when the ratio of the number of power consuming devices to the number of power source devices is too high, the selectivity of communication ports for shutting off will be limited; it is not possible to select the target ports dynamically. Therefore, the scalability requirements of the PoE system cannot be met.

To solve this technical problems, the assignee's TW application patent No.109145957 proposes a control device for PoE system having multiple power source devices. The control device comprises a plurality of control circuits and a signal bus connecting these control circuits. Each control circuit is connected to a plurality of power source devices and a plurality of port switches. Each port switch controls the power consuming state of at least one port. Each port can be connected to an electrical device. Each control circuit detect at least one power supply state combination. When a change in the power supply state combination is detected, the control signal generating circuit obtains a power consumption control signal from a power supply to power consumption look-up-table, and provides them to the plurality of port switches.

Using a system with a plurality of control circuits, in combination with a signal bus, the technical problem may be solved successfully. However, in the major embodiments all power source devices need to be connected to the plurality of control circuits. It is difficult to reduce the number of the wires, as well as the footprint of the system.

### Objectives of the Invention

One objective of the present invention is to provide a control device for power over Ethernet system having multiple power source devices, which can rapidly reduce or stop the electrical power supplied to specific ports when a power source device fails.

Another objective of the present invention is to provide a control device for power over Ethernet system having multiple power source devices, which can rapidly reduce or stop the electrical power supplied to specific ports when a power source device fails, and is suitable for a system with a greater number of power source devices and power consuming devices.

Another objective of this invention is also to provide a control device for power over Ethernet system having multiple power source devices, which can rapidly reduce or stop the electrical power supplied to specific ports when a power source device fails, and can dynamically select appropriate power consuming device to reduce or stop the power supply in compliance with the reduction or increase in the number of the power consuming devices.

Another objective of the present invention is also to provide a control method useful in the above-mentioned control device for multi-power PoE system.

Another objective of this invention is also to provide a control device for power over Ethernet system having multiple power source devices that requires a smaller amount of wires and has a smaller footprint.

### SUMMARY OF THE INVENTION

According to the first aspect of the present invention, the present invention provides a control device for power over Ethernet system having multiple power source device. The control device comprises:
power supply state code generator for connecting the plurality of power source device to receive a power supply state signal from the respective power source device and to convert the plurality of power supply state signal into a power supply state code, which is preferably a serial code;
a plurality of control circuits, each connected to a plurality of port switches, each port switch controlling a power consumption state of at least one port for connection by a power consuming device;
wherein each control circuit comprises:
an input terminal for receiving the serial power supply state code;
a first look-up-table memory to store a first power supply to power consumption look-up-table defining a corresponding relation of a plurality of power supply state code and a plurality of power consumption control combination; and
a control signal generating circuit connected to the input terminal and the first look-up-table memory and configured to: upon receipt of a serial power supply state code, pick up a power consumption control combination data corresponding to the received serial power supply state code, to generate a plurality of power consumption control signals, and provide the power consumption control signals to the plurality of port switches, to turn ON or OFF the port switches;
wherein the control signal generating circuit is configured to generate a power consumption control signal upon detection of a received power supply state code different from a previously received power supply state code;
a signal bus connected to the power supply state code generator and the plurality of control circuits; wherein, the signal bus is a serial bus. In a preferred embodiment of the present invention, the signal bus uses the IIC communication protocol.

In a preferred embodiment of the present invention, each control circuit determines the port switches to be turned ON or OFF in each case of the power supply state code according to a predetermined priority order, to generate the power consumption control signal accordingly.

In some other preferred embodiments of the present invention, each control circuit determines the port switches to be turned ON or OFF in each case of the power supply state code according to a maximum power consumption value of a predetermined group of ports and/or a total power consumption value of all ports, to generate the power consumption control signal accordingly.

In a preferred embodiment of the present invention, the first power supply to power consumption look-up-table defines a corresponding relation of a plurality of power supply state codes and a plurality of maximum power consumption values, indicating an upper limit of sum of power consumption allowable for all ports in connection with the respective control circuits, under the corresponding power supply state combination. In other embodiments of the present invention, the first power supply to power consumption look-up-table defines a corresponding relation of a plurality of power supply state codes and a plurality of maximum power consumption values, indicating an upper limit of power consumption allowable for respective ports in connection with the respective control circuits, under the corresponding power supply state combination.

In other preferred embodiments of the present invention, the first power supply to power consumption look-up-table defines a corresponding relation of a plurality of power supply state codes and a plurality of power consumption control signals, wherein the plurality of control circuits obtains a corresponding power consumption control signal from the first power supply to power consumption look-up-table, and provides the control signal.

The control device for power over Ethernet system having multiple power source devices of the present invention may further comprise a master controller. The master controller is equipped with a second look-up-table memory for storing a second power supply to power consumption look-up-table, defining a corresponding relation of a plurality of power supply state codes and a plurality of maximum power consumption values, and/or a plurality of power consumption control signals. The maximum power consumption value indicates an upper limit of sum of power consumption allowable for all ports and/or respective ports, in connection with the plurality of control circuit, under the corresponding power supply state combination.

The master controller may be configured to: in the initial stage of the system, provide a sub-table relating to a particular control circuit of the second power supply to power consumption look-up-table stored in the second look-up-table memory to each corresponding one of the plurality of control circuit. And the plurality of control circuit is further configured to: after receiving the power supply to power consumption look-up-sub-table provided by the master controller, store the power supply to power consumption look-up-sub-table in the first look-up-table memory.

The master controller may also be configured to: in the initial stage of the system, provide the second power supply to power consumption look-up-table stored in the second look-up-table memory to the plurality of control circuit. And the plurality of control circuit is further configured to: after receiving the second power supply to power consumption look-up-table provided by the master controller, store the second power supply to power consumption look-up-table in the first look-up-table memory, as the first power supply to power consumption look-up-table. In a preferred embodiment of the present invention, the plurality of control circuits may be further configured to: after receiving the second power supply to power consumption look-up-table provided by the master controller, pick up maximum power consumption values relating to the respective control circuits, to generate a power supply to power consumption look-up-table and store the obtained power supply to power consumption look-up-table in the first look-up-table memory as the first power supply control comparison table.

In a preferred embodiment of the present invention, the power supply state code includes the same number of code digits as the number of the plurality of power sources.

In some preferred embodiments of the present invention, the master controller can be one of the plurality of control circuits, and is configured to: at the initial stage of the system provide the first power supply to power consumption look-up-table or a sub-table thereof prestored in the first look-up-table memory to all other control circuits via the signal bus. In such embodiments, the other control circuits are respectively configured to: after receiving the power supply to power consumption look-up-table provided by the master controller, or a sub-table thereof, store the power supply to power consumption look-up-table in the first look-up-table memory, after necessary processing,

According to a second aspect of the present invention, the present invention provides a power over Ethernet system having multiple power source devices. The system comprises:
a plurality of power source devices;
a plurality of communication ports, each communication port to be connected by a power consuming device, to establish a signal and power connection with the power consuming device; each communication port having a port switch to control power consuming state of the port; and
a control device in connection with the plurality of power source devices and the plurality of communication ports via a network cable, to convert power supplied by the power source devices into electrical power for use by power consuming devices connected to corresponding communication ports, and to generate power consumption control signals for control of power supplied to respective communication ports from the plurality of power source devices;
wherein the control device is one of the control device for power over Ethernet system having multiple power source devices described above.

The present invention also provides a control method suitable for the control device of the multi-power Ethernet power supply system of the present invention, especially an emergency power-off program.

Other objectives, features, and advantages of the present invention can be appreciated clearly from the detailed description of the preferred embodiments by referring to the drawings. It should be noted that the description of the embodiments of the present invention is only intended to illustrate the main technical content, features, and effects of the present invention, and is not intended to limit the scope of the present invention. It is obvious for the skilled persons n this industry to derive various changes and applications based on the description of the embodiments. As long as they do not depart from the scope of the attached patent claims, they are all within the scope of the present invention.

### BRIEF DESCRIPTION OF THE DRAWINGS

FIG. 1 shows a schematic diagram of a Power over Ethernet system having multiple power source devices.

FIG. 2 shows a schematic structural diagram of an embodiment of the invented control device for power over Ethernet system having multiple power source device.

FIG. 3 show a block diagram of one example of the power supply state code generator suitable in the present invention.

FIG. 4 is sequential diagram of an embodiment of a serial power supply state code applicable to the present invention.

FIG. 5 show a block diagram of one example of the control circuit of the present invention.

FIG. 6 is a diagram showing one example of a power supply to power consumption look-up-table applicable in the invented control device for power over Ethernet system having multiple power source devices.

FIG. 7 show a flowchart of a power consumption state change operation usable in the invented control device for power over Ethernet system having multiple power source devices.

### DETAILED DESCRIPTION OF THE INVENTION

In the following, several embodiments of the invented power over Ethernet system having multiple power source devices and its control device will be described by reference to the drawings, so to demonstrate the design, features and effects of the present invention.

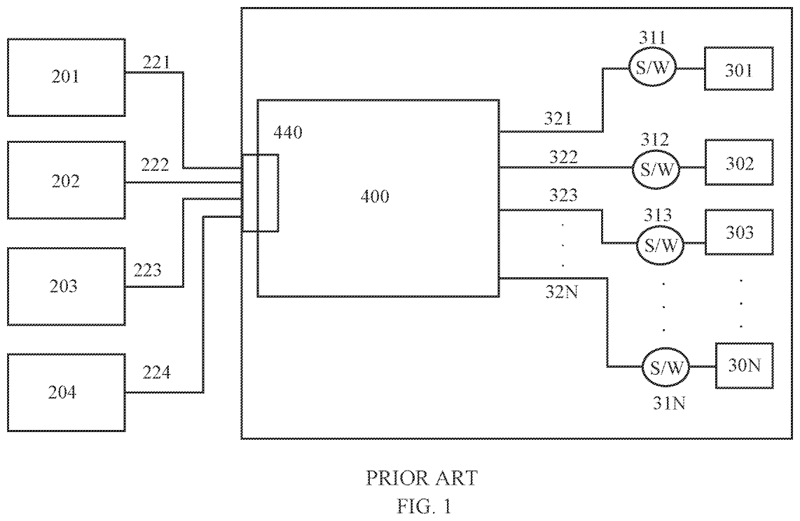

FIG. 1 shows a schematic diagram of a Power over Ethernet system having multiple power source devices. The PoE system having multiple power source devices in which the invented control device is used, is already a known technology. A PoE system usually comprises:
a plurality of power source devices 201-204, a plurality of communication ports 301, 302, 303, . . . 30N, and a control device 400.

As is well known, the plurality of power source devices 201-204 are usually a computer equipment or a network equipment, but may also be simply a power supply or other devices whose main purpose is to supply electrical power. The communication ports 301, 302, 303, . . . 30N can be connected by power consuming devices (not shown), so to establish a signal and power connection with the power consuming devices. Typical power consuming devices are networked computer equipment, network equipment, peripherals such as laser printers, telephones, scanners, cameras, projectors, monitors, microphones, headphones, intelligent household appliances. It may also be just an electrical load, such as LED lights and general household appliances. As shown in FIG. 1, each communication port 301, 302, 303, . . . 30N has a port switch 311, 312, 313, . . . 31N to control power supplied thereto, i.e., power consumption state thereof. As will be explained below, each port switch 311, 312, 313, . . . 31N is connected to the control device 400, and is controlled by the control device 400 to switch ON or OFF.

The control device 400 is in connection with the plurality of power source device 201-204 via an input terminal 411 and network lines 221-22, and with the plurality of communication ports 301, 302, 303, . . . 30N via signal lines 321-32N. The control device 400 converts electrical power supplied by the power source devices 201-204 into electrical power useful by power consuming devices in connection with the communication ports 301, 302, 303, . . . 30N. The power over Ethernet system having multiple power source devices with the above architecture, features and functions is already a mature technology and is widely used all over the world. Certain industrial standards, such as the IEEE 802.3af (15.4W) and IEEE 802.3at (25.5W) standards, are available to the public. There are also detailed descriptions in the prior art disclosures mentioned above. Readers can refer to them, if necessary for further research.

The main objective of the present invention is to provide a control device 400 with a novel architecture and a control method applicable in the control device 400, to distribute the electrical power of the plurality of power source devices 201-204 to the plurality of communication ports 301, 302, 303, . . . 30N, giving that, when one of the plurality of power source devices 201-204 fails, the electrical power provided by the remaining power source devices may be properly distributed to the plurality of communication ports 301, 302, 303, . . . 30N.

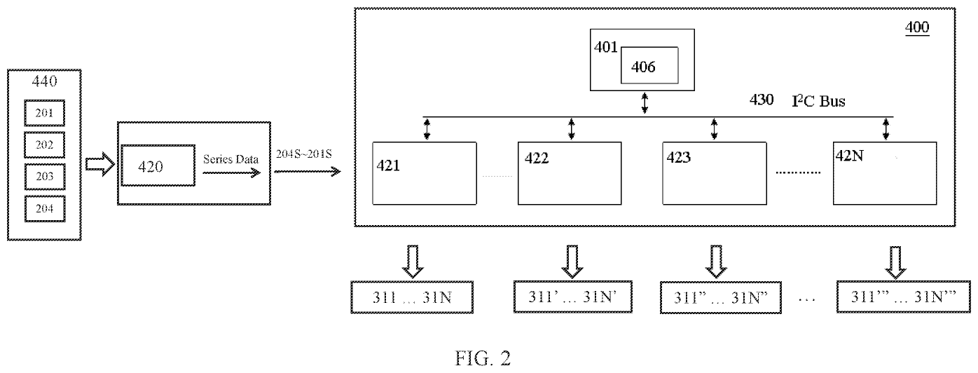

FIG. 2 is schematic diagram of one embodiment of the invented control device for PoE system having multiple power source device. As shown in this figure, the control device 400 includes a master controller 401, a plurality of control circuits 421-42N, and a signal bus 430 connecting the master controller 401and the plurality of control circuits 421-42N. The output terminals of the control circuits 421-42N are connected to a plurality of port switch 311-31N, 311′-31N′, 311″-31N″, . . . , 311′″-31N′″, each port switch 311-31N, 311′-31N′, 311″-31N″, . . . , 311′″-31N′″ controls the power consuming state of at least one communication port 301-30N (refer to FIG. 1), and each communication port 301-30N can be connected by a power consuming device (not shown), to provide electrical power and/or digital information to the power consuming devices.

Specifically, the multi-power Ethernet power supply system control device 400 controls all the port switches 311-31N, 311′-31N′, 311″-31N″, . . . , through the multiple control circuits 421-42N The opening and closing of 311′″-31N′″ is used to control whether the communication port connected to each port switch is powered. All the control circuits 421-42N send control signals to each port switch to change the open/close state of each port switch.

FIG. 2 shows N control circuits 421-42N are connected to the serial signal bus 430, and are connected communicatively to the master controller 410 via the serial signal bus 430. All or most of the control signals are transmitted via the serial signal bus 430. The control circuits 421-42N are respectively connected with the port switches 311-31N, 311′-31N′, 311″-31N″, . . . , 311′″-31N′″, to control the operation of the port switches 311-31N, 311′-31N′, 311″-31N″, . . . , 311′″-31N′″. Each port switch 311-31N, 311′-31N′, 311″-31N″, . . . , 311′″-31N′″ controls the power consumption state of at least one communication port 301-30N (not shown in FIG. 2). When a switch is ON, the corresponding port receives power from the PoE system; otherwise, when the switch is OFF, the corresponding port receives no electrical power. Each control circuit 421-42N uses the power consumption state control signal to control the above-mentioned power consumption state of the corresponding port switches 311-31N, 311′-31N′, 311″-31N″, . . . , 311′″-31N′″. Each of the communication ports 301-30N is connectable by a power consuming device (not shown).

The figure also shows that the control device for PoE system having multiple power source devices 400 further includes a power supply state code generator 420, and a signal bus 430 connecting the s power supply state code generator 420, the master controller 401 and the plurality of control circuits 421-42N. The signal bus 430 also functions as a communication channel among the plurality of control circuits 421-42N.

The signal bus 430 is preferably a serial bus. In the preferred embodiment of the present invention, the signal bus 430 using IIC communication protocol (Inter-Integrated Circuit Protocol).

As shown in FIG. 2, the control device 400 has an input terminal 440, which includes a plurality of power connector, or signal connector, for connecting a plurality of power source devices 201-204, to receive a power supply state combination signal representing a combination of power supply states of the plurality of power source devices. FIG. 2 shows the input terminal 440 is connected to 4 power source devices 201-204. However, the number of the power source devices that a PoE system can use is not particularly limited. In addition, although the main purpose of the power connectors is to detect and control, it can also be the transmission channel for the electrical power of the power source devices 201-204, for supplying power to the plurality of communication ports 301, 302, 303, . . . 30N/ In a preferred embodiment of the present invention, the power supply status signal received by the input terminal 440 can be a signal representing the power supply state of the individual power supply devices, to be normal (power good) or elsewise, and can be represented by a binary code. For example, code 1 for power good and code 0 for power failure, or vice versa.

FIG. 2 also shows the power supply state code generator 420 connected to the input terminal 440 for receiving the power supply state signal and to convert the received power supply state signal into a power supply state code, in particular a serial code of power supply state code. In the preferred embodiment of the present invention, the power supply state code generator 420 provides the serial power supply state code to the plurality of control circuits 421-42N via the signal bus 430.

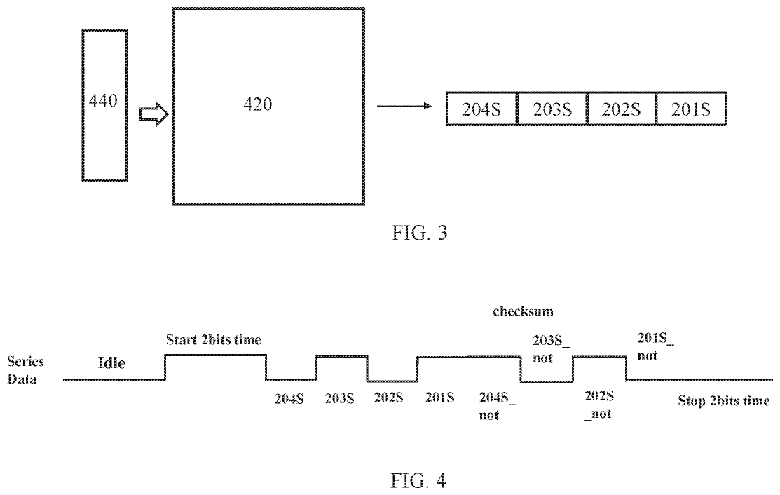

FIG. 3 shows a block diagram of an embodiment of a power supply state code generator applicable to the present invention. As shown in the figure, the power supply state code generator 420 receives the power supply state signal from the input terminal 440, and converts the power supply state signal into a power supply state codes 201S-204S, especially a serial power supply state codes 201S-204S. In a preferred embodiment of the present invention, the power supply state code generator 420 preferably includes a register, which stores a plurality of power supply state signals and outputs them in a serial form. Any other technology that can convert a power supply state signals into a power supply status code, especially a serial power supply state codes, can be applied to the present invention.

In the example shown in FIG. 3, the power supply state of each power source device 201-204 can be represented by one code. For example, code 1 represents normal power supply (power good), and code 0 represents failure or abnormal in power supply. If there are 4 power source devices 201-204, then each group of 4 codes can generate 16 power supply state combination codes, representing 16 possible power supply states. Of course, the above coding method is not any technical limitation. Other technologies that can convert the power supply state of a plurality of power source devices into a code, suitable for transmission in a signal bus can be applied to the present invention.

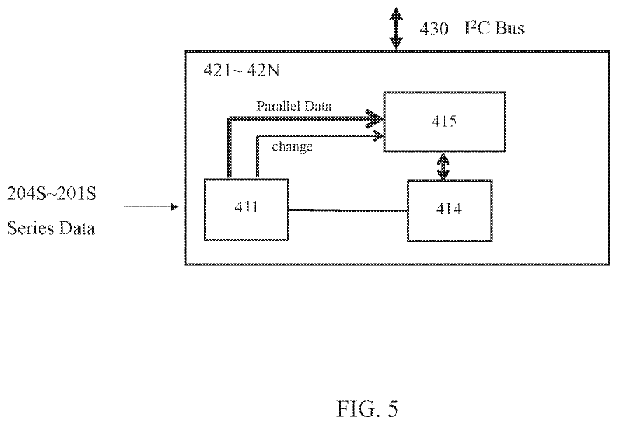

FIG. 4 is sequential diagram of an embodiment of a serial power supply state code applicable to the present invention. The sequential diagram shown in FIG. 4 is only one possible application of this embodiment. According to this embodiment, a possible form of a useful sequential diagram may include a start signal, a power supply control signals, verification (checksum) signal, and an end signal. The example shown in FIG. 4 includes:

A start signal in the form of a two-bit H signal.

A power supply state signal with H for power good state, and L for failure state. Its sequence can be in the order of 204S, 203S, 202S and 201S.

A verification signal in the form reverse to the power supply state signal.

An end signal in the form of a two-bit L signal.

In this example, the power supply state signal is HLHL, forming a serial power supply state code of 1010 of the sequence power status code. The entire power supply state signals have the following code: 11_start, 0,1,0,1,1,0,1,0, 00_stop. The examples given above provides a signal that is easy to detect and decode. Other coding techniques that can generate a signal easy to detect and decode can also be applied to the present invention.

FIG. 5 is a block diagram of one example of the control circuit 421-42N applicable in the invented control device for power over Ethernet system having multiple power source devices. As shown in the figure, each of the control circuit 421-42N has an input terminal 411, for connecting a plurality of power source devices 201-204, to receive a power supply state code representing a combination of power supply states of the plurality of power source devices, and other useful signals.

In the preferred embodiments, each control circuit 421-42N may comprise a first look-up-table memory 416, to store a first power supply to power consumption look-up-table. Each control circuit 421-42N may further provide a control signal generating circuit 414, configured to generate a power consumption control signal according to a power supply state code, received from the power supply state code generator 420, and a corresponding data or value in the first power supply to power consumption look-up-table, and provide the generated control signal to the plurality of port switches, to control the ON/OFF state of the plurality of port switches.

In the control device for PoE system having multiple power source devices 400 of the present invention, there are varies of possible ways to generate a control signal, that is, a power consumption control signal. In some specific embodiments, each control circuit determines which port switches to turn ON or OFF, according to a particular priority order, in correspondence with a power supply state code. In other embodiments the respective control circuits determine the power consumption state of the plurality of port switches, i.e., which port switches to turn ON or OFF, in accordance with a predetermined maximum power consumption value corresponding to each port and/or a predetermined maximum total power consumption value of a plurality of ports.

In other embodiments, the first power supply to power consumption look-up-table defines a corresponding relation of a plurality of power supply state codes and a plurality of power consumption control signals. In such embodiments, the plurality of control circuits is configured to pick up a power consumption control signal corresponding to a received power supply state code from the first power supply to power consumption look-up-table and provide the control signal to the plurality of port switches.

Please refer to FIG. 2. As shown in the figure, the master controller 401 of the invention further comprises a second look-up-table memory 406, to store a second power supply to power consumption look-up-table. The first power supply to power consumption look-up-table may be a sub-table of the second power supply to power consumption look-up-table and defines the corresponding relation of a plurality of serial power supply state codes and a plurality of power consumption combination of respective control circuits.

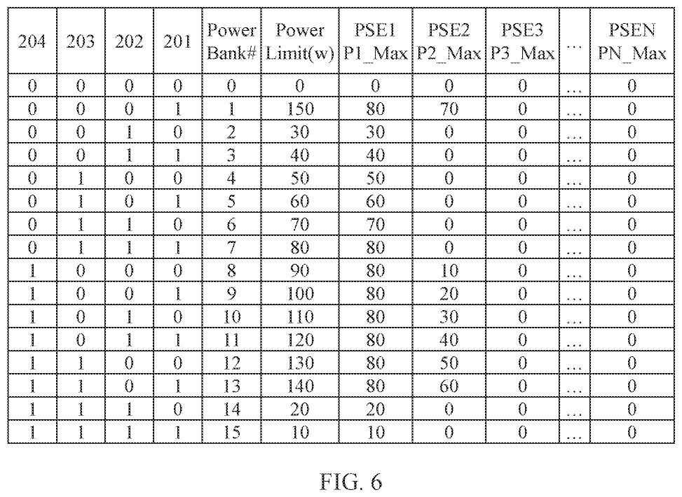

Specifically, the second power supply to power consumption look-up-table stored in the master controller 401 of the present invention may define a corresponding relation of a plurality of power supply state codes and variety of corresponding, useful data. FIG. 6 is a diagram showing one example of the second power supply to power consumption look-up-table applicable in the invented control device for power over Ethernet system having multiple power source devices. As shown in the table, values in the 4 rows from the left represent the power supply states of the power supply devices connected to the input terminal 440. The table shows that the input terminal 440 is connected to 4 power supply devices 204, 203, 202, and 201. Code 1 indicates the normal state (power good) of a power supply device; Code 0 indicates the power failure state of a power supply device. Each group (line) forms a power supply state code, representing a power supply state combination. This table exhaustively lists all 16 possible power supply state combinations of the 4 power supply devices. However, in application, the power supply to power consumption look-up-table does not necessarily list all possible combinations.

Moving forward to the right side, the field right next to the power supply state code is the power supply state combination code Power Bank #. This code is the result of converting the binary value of the power supply state combination values into its hexadecimal value. This embodiment tries to assigns a code to each power supply state combination in an intuitive way. Other methods that can assign codes for various combinations of power supply states can be applied to the present invention. Following the power supply state combination code is the total power supply value Power_Limit of the system, representing the maximum power that all the power source devices can supply under the corresponding power supply state. The unit of the value is not limited; it can be a current, a power or else. The value of this field is usually filled in manually. However, it may also be generated by the system, as a result of auto inspection. In the case of manual setting, the value is usually set according to management purposes, and does not necessarily represent the upper limit of the physical sum of power supply or power consumption of each group of communication ports.

The fields following the total power supply are the maximum power consumption values PSE1 P1_MAX to PSEN PN_MAX assigned to the port switch/communication port of/controlled by each control circuit for each of the power supply state combinations. The row number of this field is usually the same as the number of the port switch, but may be different. The listed port switch codes relate to the port switches that are controlled by the power consumption state change operation of the present invention. Port switches not subject to the control need not be listed in the table. Further, code value 0 indicates the port needs to be shut off under the power supply state combination of the same line/column, whereby power supplied to this port must stop. All non-zero values in the field indicate that power supplied to these ports need not be shut off, while the specific non-zero values are actually for the manager's reference, because they mean nothing but “non-zero” to the system.

In addition to the power supply to power consumption look-up-table described above, other forms and/or designs of the power supply to power consumption look-up-table can also be applied to the present invention.

The second power supply to power consumption look-up-table shown in FIG. 6 defines a corresponding relation of a plurality of power supply state codes and a plurality of maximum power consumption values, indicating an upper limit of sum of power consumption allowable for all ports connected to the plurality of control circuits, under the corresponding power supply state combination. The master controller 401 provides the second power supply to power consumption look-up-table to each control circuit 421-42N, in the form of a full table or a sub-table, and the control circuit 421-42N store it in the first look-up-table memory 415, as the first power supply to power consumption look-up-table. When a power failure event occurs, the individual control circuits 421-42N determine the port switches that should be powered off according to the first power supply to power consumption look-up-table, and generate a power consumption control signal based on the judgment result and send it to each of the connected port switches 311-31N, 311′-31N′, 311″-31N″, . . . , 311′″-31N′″. In the preferred embodiments, the master controller 410 uses a serial signal bus 430 to transmit the second power supply to power consumption look-up-table, or a sub-table thereof, to the plurality of control circuits 421-42N. According to a preferred embodiment of the present invention, the serial signal bus 430 preferably uses the IIC (Inter-Integrated Circuit Protocol) communication protocol.

Taking the table of FIG. 6 as an example, in the first look-up-table memory 415 of the first control circuit 421, the first power supply to power consumption look-up-table includes the fields 204, 203, 202, 201 and PSE1 P1_MAX, only, while in the first look-up-table memory 415 of the second control circuit 422, the first power supply to power consumption look-up-table includes the fields 204, 203, 202, 201and PSE2 P2_MAX, only, And so on.

In the preferred embodiments of the present invention, the master controller 410 may be configured to provide at the initial stage of the system, a sub-table relating to each of the plurality of control circuits 421-42N of the second power supply to power consumption look-up-table, pre-stored in the second look-up-table memory 415, to each corresponding control circuit 421-42N. Alternatively, the master controller 401 can provide the whole second power supply to power consumption look-up-table to the plurality of control circuit 421-42N, whereby individual control circuits 421-42N then pick up the relative information from the second power supply to power consumption look-up-table and save it in the first look-up-table memory 415, as the first power supply to power consumption look-up-table. The second power supply to power consumption look-up-table or its sub-table is preferably provided via the signal bus 430.

In implementation, a control signal generating circuit 414 is provided in each control circuit 421-42N. The control signal generating circuit 414 is in connection with the input terminal 411 and detects the power supply state of the plurality of power source devices 201-204, that is, the value of the power supply state code. The first look-up-table memory 415 of each control circuit 421-42N stores the first power supply to power consumption look-up-table, indicating the corresponding relation of a plurality of power supply state code and a plurality of maximum power consumption values, defining the upper limit of power consumption allowable for each control circuit. The first power supply to power consumption look-up-table may be the second power supply to power consumption look-up-table, or a sub-table thereof, and provides information such as the sums of the maximum power consumption values of the port switches 311-31N, 311′-31N′, 311″-31N″, . . . , 311′″-31N′″ associated with each control circuit 421-42N. In application, the value of the second power supply to power consumption look-up-table can be manually set, or can be automatically set by the main controller 401 at the initial stage.

The control signal generating circuit 414 is connected to the first look-up-table memory 415, and generates a power consumption control signal in correspondence with a received power supply state code, when the received power supply state code is different from a previously received power supply state code, and provides the generated control signal to the connected port switches 311-31N, 311′-31N′, 311″-31N″, . . . , 311′″-31N′″.

In a specific embodiment, each control circuit determines the power consumption state of the plurality of port switches, according to a predetermined priority order. In such embodiments, the control signal generating circuit 414 of the plurality of control circuits 421-42N picks up a maximum power consumption value corresponding to a received power supply state code from the first power supply to power consumption look-up-table, or a sub-table thereof, if the received power supply state code is different from a previously received power supply state code, whereby a power consumption state change program is activated. In a preferred embodiment, the maximum power consumption value represents an upper limit of power consumption by a particular port and/or an upper limit of total power consumption value of all connected ports, PSE1 P1_Max.

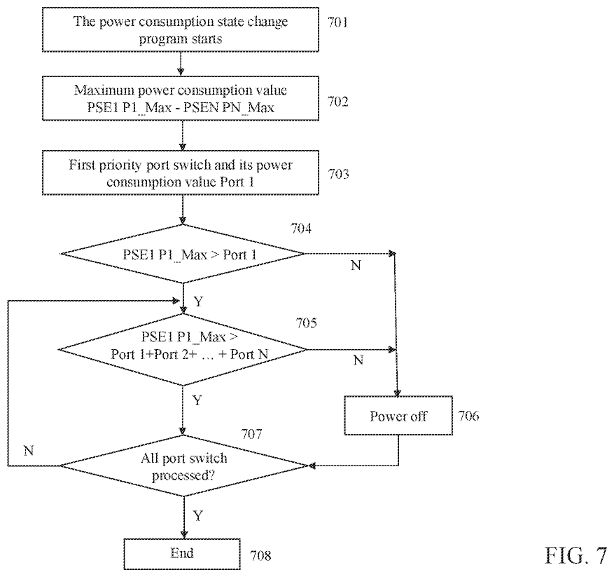

FIG. 7 show a flowchart of a power consumption state change operation usable in the invented control device for power over Ethernet system having multiple power source devices. Hereinafter, an embodiment of the power consumption state change program will be described based on FIG. 7.

As shown in the figure, in step 701, the power consumption state change program is started by the control signal generating circuit 414 of the respective control circuits 421-42N, after a change in the power supply state code is detected. In a preferred embodiment of the present invention, the power supply state code indicates a new power supply state combination. For example, the power supply state code may be a code, such as the number in the field “Power Bank#” in FIG. 6. In step 702 the control signal generating circuit 414 of the respective control circuits 421-42N picks up a corresponding maximum power consumption value PSE1 P1_Max-PSEN PN_MAX from the first power supply to power consumption look-up-table. For example, the first power supply to power consumption look-up-table of the control circuit 422 includes all the values in the fields “Power Bank#” and “PSE2 P2_Max” in FIG. 3. When the power supply state code indicates that the new power supply state combination is code 9, the control signal generation circuit 414 picks up the corresponding maximum power consumption value 20. And so on.

In step 703, the control signal generating circuit 414 identifies a port switch with the highest priority according to a priority table and obtains the power consumption value Port 1 of the port switch. In step 704, the control signal generating circuit 414 compares the maximum power consumption value PSE1 P1_Max with the power consumption value Port 1 of the first priority port switch. If PSE1 P1_Max>Port 1, it determines that Port 1 is continuously powered. Otherwise, it determines Port 1 shall be powered off, and in step 706 a power consumption control signal to shut off power to Port 1 and ports with lower priority is provided to the corresponding ports. If the determination in step 704 is YES, in step 705 the maximum power consumption value PSE1 P1_Max is compared with the sum of the power consumption value of the first priority port switch and the next priority port switch, Port 1+Port2. If PSE1 P1_Max>Port 1+Port 2, it is determined that Port 2 is continuously powered. Otherwise, it determines Port 2 to be powered off, and the step goes to 506, wherein a power consumption control signal to shut off power to Port 2 and ports with lower priority is provided to the corresponding ports. If the determination in step 705 is YES, it determines in step 707 whether the power consumption values of all the port switches have been calculated. If NO, the step returns to 705, to compares the maximum power consumption value PSE1 P1_Max the sum of the first and a predetermined orders of priorities port switch, Port 1+Port 2+ . . . +Port N. If the determination in step 707 is YES, the power consumption state change program ends.

In the foregoing embodiment, if any port switch is determined to be powered off, the control circuit 421-42N determines that port switch and the port switch with a lower priority should be powered off. It is however possible to consider both the power consumption and the priority of each port switch at the same time. That is, after determining that a specific port switch should be powered off, continue to determine whether the sum of the power consumption of all the port switches with a higher priority and the port switch of the next priority exceeds the power supply upper limit. If not, it is determined that the port switching with the next priority does not need to power off. For example, in the foregoing step 705 the control circuit determines Port 2 shall be powered off. Following this, the control circuit may continue to determine if the following is true: PSE1 P1_Max>Port 1+Port 2+Port 4? Although this approach helps to keep as many ports uninterrupted as possible, the disadvantage is that it consumes a long time.

In other embodiments of the present invention, the first power supply to power consumption look-up-table includes a plurality of power supply state codes and corresponding plurality of power consumption control signals; the plurality of control circuits obtains from the first power supply to power consumption look-up-table a corresponding power consumption control signals and provide the control signal to the plurality of port switches. The advantage of this way is the control signals can be directly generated. However, the disadvantage is, if the number of communication ports connected to the system is too large, the first and/or second power supply to power consumption look-up-table will be too large to handle.

In the power state change program of the present invention, if each control circuit is in control of 8 port switches, each port switch needs 50 μs to complete the power consumption state change program, therefore each control circuit needs at most 400 μs (50 μs×8 ports) to complete the emergency shut off operation. In a system with a plurality of power supply devices, 400 μs would be the longest time needed. Shutting off necessary port switches with a very short time can thus be accomplished.

1. A control device for power over Ethernet system having multiple power source devices, comprising:
power supply state code generator for connecting the plurality of power source devices to receive a power supply state signal from the respective power source device and to convert the plurality of power supply state signal into a power supply state code;
a plurality of control circuits, each connected to a plurality of port switches, each port switch controlling a power consumption state of at least one port for connection by a power consuming device;
wherein each control circuit comprises:
an input terminal for receiving the power supply state code;
a first look-up-table memory to store a first power supply to power consumption look-up-table defining a corresponding relation of a plurality of power supply state code and a plurality of power consumption control combination data; and
a control signal generating circuit connected to the input terminal and the first look-up-table memory and configured to: upon receipt of a power supply state code, pick up a power consumption control combination data corresponding to the received power supply state code, to generate a plurality of power consumption control signals, and provide the power consumption control signals to the plurality of port switches, to turn ON or OFF the port switches;
wherein the control signal generating circuit is configured to generate a power consumption control signal upon detection of a received power supply state code different from a previously received power supply state code;
a master controller having a second look-up-table memory for storing a second power supply to power consumption look-up-table, defining a corresponding relation of a plurality of power supply state codes and a plurality of maximum power consumption values; wherein the maximum power consumption value indicates an upper limit of a total power consumption allowable for all ports in connection with the plurality of control circuit, under the corresponding power supply state combination; and
a signal bus connected to the power supply state code generator and the plurality of control circuits; wherein, the signal bus is a serial bus;
wherein the master controller is configured to: in the initial stage of the system, provide a sub-table relating to a particular control circuit of the second power supply to power consumption look-up-table to each corresponding one of the plurality of control circuit; and wherein the plurality of control circuit is further configured to: after receiving the power supply to power consumption look-up-sub-table provided by the master controller, store the power supply to power consumption look-up-sub-table in the first look-up-table memory.

2. The control device for power over Ethernet system having multiple power source device according to claim 1, wherein the signal bus uses the IIC communication protocol.

3. The control device for power over Ethernet system having multiple power source device according to claim 1, wherein the power supply state code is a serial code.

4. The control device for power over Ethernet system having multiple power source device according to any one of claims 1-3, wherein the power consumption control combination data comprises a maximum power consumption value and wherein each control circuit determines which port switches to turn ON or OFF, according to a particular priority order, in correspondence with a power supply state code.

5. The control device for power over Ethernet system having multiple power source device according to claim 4, wherein the maximum power consumption values indicate an upper limit of sum of power consumption allowable for all ports in connection with the respective control circuits, under the corresponding power supply state code.

6. The control device for power over Ethernet system having multiple power source device according to any one of claims 1-3, wherein the power consumption control combination data comprises a power consumption control signal.

7.-9. (canceled)

10. A control device for power over Ethernet system having multiple power source device, comprising:
power supply state code generator for connecting the plurality of power source device to receive a power supply state signal from the respective power source device and to convert the plurality of power supply state signal into a power supply state code:
a plurality of control circuits, each connected to a plurality of port switches, each port switch controlling a power consumption state of at least one port for connection by a power consuming device;
wherein each control circuit comprises:
an input terminal for receiving the serial power supply state code;
a first look-up-table memory to store a first power supply to power consumption look-up-table defining a corresponding relation of a plurality of power supply state code and a plurality of power consumption control combination data; and
a control signal generating circuit connected to the input terminal and the first look-up-table memory and configured to: upon receipt of a serial power supply state code, pick up a power consumption control combination data corresponding to the received serial power supply state code, to generate a plurality of power consumption control signals, and provide the power consumption control signals to the plurality of port switches, to turn ON or OFF the port switches;
wherein the control signal generating circuit is configured to generate a power consumption control signal upon detection of a received power supply state code different from a previously received power supply state code;
a master controller having a second look-up-table memory for storing a second power supply to power consumption look-up-table, defining a corresponding relation of a plurality of power supply state codes and a plurality of maximum power consumption values; wherein the maximum power consumption value indicates an upper limit of a total power consumption allowable for all ports in connection with the plurality of control circuit, under the corresponding power supply state combination; and
a signal bus connected to the power supply state code generator and the plurality of control circuits; wherein, the signal bus is a serial bus;
wherein the master controller is configured to: in the initial stage of the system, provide the second power supply to power consumption look-up-table to the plurality of control circuit; and the plurality of control circuit is further configured to: after receiving the second power supply to power consumption look-up-table provided by the master controller, store the second power supply to power consumption look-up-table in the first look-up-table memory, as the first power supply to power consumption look-up-table.

11. The control device for power over Ethernet system having multiple power source device according to claim 10, wherein the plurality of control circuits is further configured to: after receiving the second power supply to power consumption look-up-table provided by the master controller, pick up maximum power consumption values relating to the respective control circuits from the second power supply to power consumption look-up-table, to generate a first power supply to power consumption look-up-table.

12. The control device for power over Ethernet system having multiple power source device according to claim 10, wherein the master controller is one of the plurality of control circuits.

13. The control device for power over Ethernet system having multiple power source device according to claim 1, wherein the power supply state code comprises the same number of code digits as the number of the plurality of power sources.

14. The control device for power over Ethernet system having multiple power source device according to claim 1, wherein the power supply state code comprises the same number of code digits as the number of the plurality of power sources.

15. The control device for power over Ethernet system having multiple power source device according to claim 1, wherein the master controller is one of the plurality of control circuits.

16. The control device for power over Ethernet system having multiple power source device according to claim 1, wherein the power supply state code comprises the same number of code digits as the number of the plurality of power sources.

17. The control device for power over Ethernet system having multiple power source device according to claim 4, wherein the power supply state code comprises the same number of code digits as the number of the plurality of power sources.

18. The control device for power over Ethernet system having multiple power source device according to claim 10, wherein the signal bus uses the IIC communication protocol.

19. The control device for power over Ethernet system having multiple power source device according to claim 10, wherein the power supply state code is a serial code.

20. The control device for power over Ethernet system having multiple power source device according to claim 10, wherein the power consumption control combination data comprises a maximum power consumption value and wherein each control circuit determines which port switches to turn ON or OFF, according to a particular priority order, in correspondence with a power supply state code.

21. The control device for power over Ethernet system having multiple power source device according to claim 14, wherein the maximum power consumption values indicate an upper limit of sum of power consumption allowable for all ports in connection with the respective control circuits, under the corresponding power supply state code.

22. The control device for power over Ethernet system having multiple power source device according to claim 10, wherein the power consumption control combination data comprises a power consumption control signal.
